(19) United States
(12) Patent Application Publication
(10) Pub. No.: US 2017/0012255 A1
(43) Pub. Date: Jan. 12, 2017

(54) BATTERY CONVERTER

(71) Applicant: Robert Boutin, Calgary (CA)

(72) Inventor: Robert Boutin, Calgary (CA)

(21) Appl. No.: 15/205,254

(22) Filed: Jul. 8, 2016

(30) Foreign Application Priority Data
Jul. 8, 2015 (CA) 2896303

(51) Int. Cl. H01M 2/10

(52) U.S. Cl. CPC H01M 2/1033; H01M 2/105; H01M 2220/30

(57) ABSTRACT

A battery conversion device is provided. The battery conversion device has a generally cylindrical body with an open top end, a bottom end, and an inner aperture sized to be larger than an outer diameter of a size AA battery. A conductor plate having a diameter greater than the diameter of the size AA battery is provided on the bottom end of the body. A battery conversion system using the device and methods of using the device and system are also provided.

The present invention relates to a system and method to allow smaller sized batteries to be used in devices designed to use larger batteries.

### BACKGROUND

Numerous portable electrical devices are powered with replaceable batteries. These replaceable batteries can either be single-use (disposable) and only used once and then discarded after their single use or rechargeable that can be discharged and then recharged multiple times by the user with a battery charger. While batteries come in many different sizes from very small cells used for watches, key fobs and other small devices, to larger batteries for cars and other vehicles and even larger, there is a range of sizes of cylindrical shaped batteries that are commonly used for most portable electronics. These battery sizes are commonly classified as size AAA, size AA, size C and size D (although theses sizes may be called by different names in some cases).

These commonly sized batteries are all cylindrical in shape with a height that is greater than their diameter. However, the different sizes vary based on height and diameter. Typically, they all produce 1.5 volts when new, although certain types like rechargeable nickel-cadmium or lithium may produce different voltages. So the different sizes have the same voltage, just differ based on battery life. Each of these sizes of batteries has a positive end or terminal with a nub on top and a negative end or terminal on their bottom end with a flat contact surface. The sides of these batteries are not used as terminals and are not conductive. All of these sizes have been used for many years and are ubiquitous. However, the size AA and AAA batteries tend to be a bit more common and used in more devices with the size C and D batteries used in fewer electronic devices.

While these battery sizes all provide approximately the same voltage, they will not all fit in the same device. Each electronic device is designed to fit a specific size of battery and batteries of a different size will not fit because they differ in both height and diameter, preventing a larger sized battery from fitting in the compartment because it is too large with smaller batteries not being long enough to reach the contact terminals in the electronic device.

There are some devices designed to try and allow smaller sized batteries to be used in place of larger sized batteries, but they can have drawbacks in that they may not work in every situation as well as the proper sized battery and have a number of parts that can be finicky to assemble together.

### SUMMARY OF THE INVENTION

A device, system, and method to allow smaller sized batteries to be used in place of larger sized batteries is provided.

In an aspect, a battery conversion device comprises a generally cylindrical body comprising an open top end, a bottom end, and an inner aperture sized to be larger than an outer diameter of a size AA battery, and a conductor plate having a diameter greater than the diameter of the size AA battery and provided on the bottom end of the body.

In a further aspect, a battery conversion system comprises a first piece having a generally cylindrical body with an open top end, a bottom end, an inner aperture sized to be larger than an outer diameter of a size AAA battery and a conductor plate provided on the bottom end, and a second piece having a generally cylindrical body with an open top end, a bottom end, an inner aperture sized to be larger than an outer diameter of the first piece and a conductor plate having a diameter greater than the diameter of the inner aperture of the first piece and provided on the bottom end of the second piece.

In yet a further aspect, a method of converting a smaller battery to a larger battery comprises the steps of providing a battery conversion device comprising a generally cylindrical body having an open top end, a bottom end, and an inner aperture sized to be larger than an outer diameter of a size AA battery and a conductor plate having a diameter greater than the diameter of the size AA battery and provided on the bottom end of the body, and inserting a negative end of a size AA battery in the inner aperture whereby the negative end of the size AA battery contacts the conductor plate in the bottom end of the body.

In yet a further aspect, a method of substituting a smaller battery for a larger battery comprises the steps of providing a first piece having a generally cylindrical body with an open top end, a bottom end, an inner aperture sized to be larger than an outer diameter of a size AAA battery and a conductor plate provided on the bottom end, providing a second piece having a generally cylindrical body with an open top end, a bottom end, an inner aperture sized to be larger than an outer diameter of the first piece and a conductor plate having a diameter greater than the diameter of the inner aperture of the first piece and provided on the bottom end of the second piece, and inserting one of a negative end of a size AA battery and the bottom end of the first piece in the inner aperture of the second piece whereby one of the negative end of the size AA battery and the conductor plate of the first piece contacts the conductor plate in the bottom end of the body of the second piece.

The device could be simple to assemble and use, and could be used with batteries of various dimensions.

### DESCRIPTION OF THE DRAWINGS

An example embodiment of the present invention is described below with reference to the accompanying drawings, in which:

FIG. 1 is a perspective view of a battery conversion system;

FIG. 2 is a top view of a first piece of the battery conversion system shown in FIG. 1;

FIG. 3 is a side sectional view of the first piece taking along sectional line 3-3′ shown in FIG. 2;

FIG. 4 is a top view of a second piece of the battery conversion system shown in FIG. 1;

FIG. 5 is a side sectional view of the second piece taken along sectional line 5-5′ shown in FIG. 4;

FIG. 6 is a top view of a third piece of the battery conversion system shown in FIG. 1;

FIG. 7 is a side sectional view of the third piece taken along sectional line 7-7′ shown in FIG. 6;

FIG. 8 is a perspective view of a second piece of a battery conversion system; and

FIG. 9 is a schematic view of the battery conversion system incorporating the second piece of FIG. 8, with the top row showing a top view of the first, second, and third pieces and the bottom row showing a bottom view of the first, second, and third pieces.

### DETAILED DESCRIPTION OF THE ILLUSTRATED EMBODIMENTS

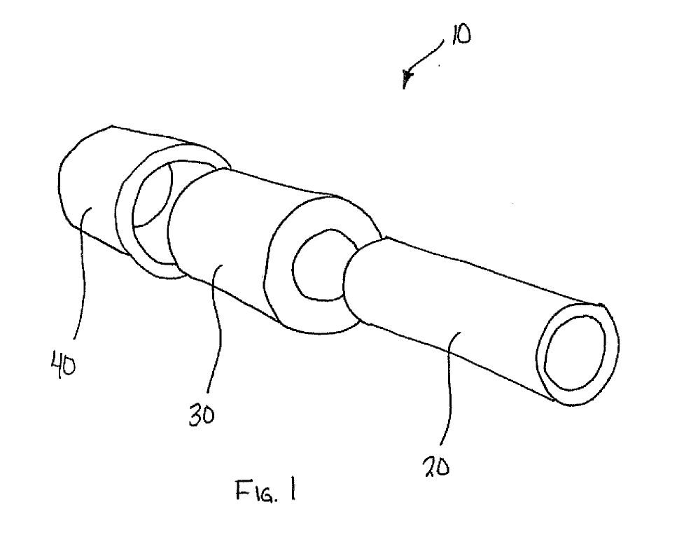

FIG. 1 illustrates a three-piece battery conversion system 10 that can allow a user to substitute a smaller battery for a larger battery. Using the three-piece battery conversion system 10 a size AAA battery can be used in place of a size AA battery, size C battery or a size D battery. Additionally, a size AA battery can be used in place of a size C battery or a size D battery. Finally, a size C battery can be used in place of a size D battery because of the battery conversion system 10.

The battery conversion system 10 can comprise: a first piece 20 that can allow a size AAA battery to be used in place of a size AA battery; a second piece 30 that can allow a size AA battery to be used in place of a size C battery; and a third piece 40 that can allow a size C battery to be used in place of a size D battery. Additionally, by combining pieces, the combination of pieces allows an even wider range of substitutions. The first piece 20 and the second piece 30 can be used to together to allow a size AAA battery to be used in place of a size C battery. The second piece 30 and third piece 40 can be used together to allow a size AA battery to be used in place of a size D battery. Finally, the first piece 20, second piece 30 and third piece 40 can be used together to allow a size AAA battery to be used in place of a size D battery.

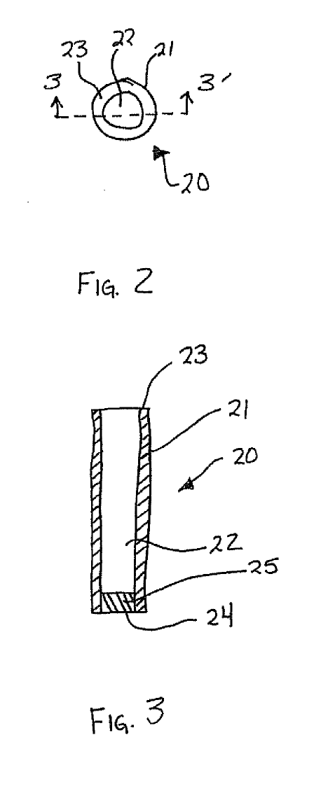

Because size AAA, size AA, size C and size D batteries all have approximately the same voltage, they can all be used interchangeably with each other. It is only the dimensions of the different sizes of battery, i.e. their diameters and heights, that prevent them from being used in electronic devices designed for different sized batteries. Using a smaller sized battery in place of a larger battery with the battery conversion system 10 should operate fine with the only possible difference being that a smaller battery may not have as long a battery life in an electronic device meant to be used with a larger battery than the battery life the larger battery might have. FIGS. 2 and 3 illustrate the first piece 20 of the battery conversion system 10. The first piece 20 can have a generally cylinder shaped body 21 with an inner aperture 22 sized to receive a size AAA battery. In one aspect, the inner diameter of the inner aperture 22 could be sized to receive a size AAA battery, with the inner diameter of the inner aperture 22 being sized slightly larger than an outer diameter of a conventional size AAA battery. In one aspect, the inner diameter of the inner aperture 22 could be approximately 11 mm. The outer diameter of the generally cylindrical shaped body 21 could be sized to conform generally with the outer diameter of a size AA battery, but this is not strictly necessary and the outer diameter of the cylindrical shaped body 21 could be made smaller than the outer diameter of a size AA battery. In one aspect, the outer diameter of the generally cylinder shaped body 21 could be approximately 14 mm.

The body 21 of the first piece 20 will have an open top end 23 so that a positive end of a size AAA battery can extend upwards out of the open top end 23 and a bottom end 24 with a conductor plate 25 provided on the bottom end 24 so that a negative end of a size AAA battery inserted in the inner aperture 21 can contact the conductor plate 25 in the bottom end 24 of the body 21. In this manner, the positive end of a size AAA battery inserted in the aperture 22 passing through the body 21 of the first piece 20 can contact a positive terminal of a device sized for a size AAA battery and the conductor plate 25 that is in electrical communication with the negative end of the size AAA battery can contact a negative terminal of the device.

In one aspect, the height of the body 21 could be approximately 46 mm with the conductor plate 25 having a height of approximately 5 mm causing the inner aperture 22 in the first piece to be approximately 41 mm deep.

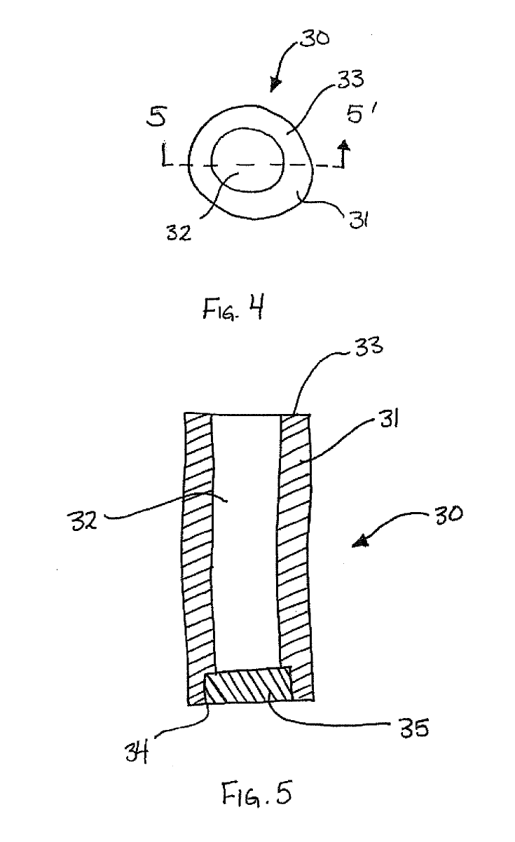

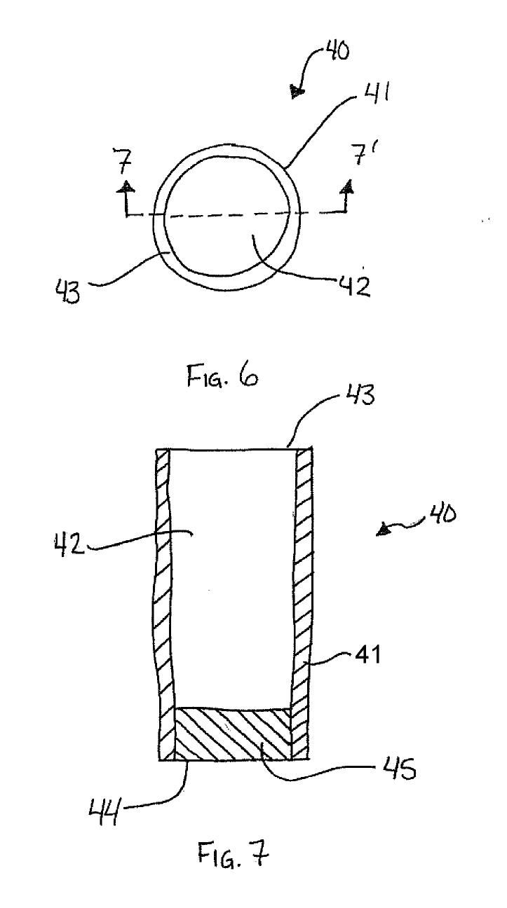

FIGS. 4 and 5 illustrate the second piece 30 of the battery conversion system 10. The second piece 30 can have a generally cylinder shaped body 31 with an inner aperture 32 sized to receive a size AA battery. In one aspect, the diameter of the inner aperture 32 could be approximately 14 mm to receive a size AA battery and allow the first piece 20 to be inserted in the inner aperture 32 of the second piece 30. The outer diameter of the generally cylindrical shaped body 31 could be sized to conform generally with the outer diameter of size C battery, but this is not strictly necessary. In one aspect, the outer diameter of the generally cylinder shaped body 31 could be approximately 25 mm.

The body 31 of the second piece 30 can have an open top 33 so that a positive end of a size AA battery inserted negative end first in the inner aperture 32 of the body 31 can extend upwards out of the open top 33 allowing the nub on the positive end of the size AA battery to extend above the open top 33 of the body 31.

A conductor plate 35 can be provided on a bottom end 34 of the body 31 to provide a negative terminal when the second piece 30 is used. The conductor plate 35 can have a diameter that is greater than the inner diameter of the inner aperture 32 provided in the body 31 of the second piece 30. In this manner, the edges of the conductor plate 35 will extend out beyond the edges of a typical negative terminal of a size AA battery. In one aspect, the conductor plate 35 can have a diameter of approximately 17 mm causing the edges of the conductor plate 35 to extend out 3 mm more than the inner diameter of the inner aperture 32.

A typical negative terminal on a size AA battery is approximately 9 mm in diameter. Placing the negative terminal of a size AA battery in electrical communication with the conductor plate 35 by inserting the size AA battery negative terminal end first in the aperture 32 of the body 31 of the second piece 30 will provide the second piece 30 with an effectively widened negative terminal in the form of the larger diameter conductor plate 35. This makes the conductor plate 35 more suited to some electronic devices that are designed to use size C batteries. The spring or other contact point that is meant to make contact with the negative terminal of a C battery in some of these electronic devices can be quite large and in some cases may make poor contact with a negative terminal the size of a negative terminal on a size AA battery. If a negative terminal on the second piece 30 was sized close in size to the size of a negative terminal on a size AA battery or if the negative terminal on a size AA battery was used as the contact point for these devices, there might be poor to no electrical contact with the contact portion of the electronic device causing it to work poorly or even not at all without the enlarged conductor plate 35.

When a size AA battery is inserted negative terminal first through the open top 33 of the body 31 into the inner aperture 32, the size AA battery can come to rest with its negative terminal in contact with the conductor plate 35. The positive terminal of the size AA battery will extend above the open top 33. In this manner, the positive end of a size AA battery inserted in the aperture 32 passing through the body 31 can contact a positive contact point of an electronic device designed to use a size C battery and the conductor plate 35, which will be in electrical communication by contact with the negative end of the size AA battery, can contact a negative contact of the electronic device causing the size AA battery to provide power to the electronic device in the same manner a size C battery would.

In one aspect, the height of the second piece 30 could be approximately 44 mm and the conductor plate 35 could be approximately 2 mm in height causing the inner aperture 32 to be approximately 42 mm deep.

To use a size AAA battery in place of a size C battery, the size AAA battery can be inserted into the inner aperture 22 of the first piece 20 and the first piece 20 inserted into the inner aperture 32 of the body 31 of the second piece 30. In this manner, the size AAA battery, first piece 20 and second piece 30, altogether, can be used in an electronic device meant to take a size C battery.

FIGS. 6 and 7 illustrate the third piece 40 of the battery conversion system 10. The third piece 40 can also have a generally cylindrical shaped body 41 with an inner aperture 42 sized to receive either a size C battery or the second piece 30 of the battery conversion system 10. In one aspect, the diameter of inner aperture 42 could be approximately 25 mm. The outer diameter of the generally cylindrical shaped body 41 could be sized to conform generally with the outer diameter of size D battery, but this is not strictly necessary as it could be smaller than a size D battery. In one aspect, the outer diameter of the generally cylinder shaped body 41 could be approximately 31 mm.

The body 41 of the third piece 40 can have an open top 43 so that a positive end of a size C battery can extend upwards out of the open top 43 when the battery is inserted negative terminal end first in the aperture 42. A conductor plate 45 can be provided on a bottom end 44 of the body 41. In one aspect, the conductor plate 45 can be approximately the same diameter as the diameter of the inner aperture 42.

When a size C battery is inserted through the open top 43 of the body 41 into the inner aperture 42 with its negative terminal end inserted first, the size C battery can come to rest with its negative terminal end in contact with the conductor plate 45. The negative terminal end of the size C battery can come into contact with the conductor plate 45 in the bottom of the third piece 40 thereby placing the negative terminal end of the size C battery in electrical communication with the conductor plate 45.

In this manner, by inserting a size C battery negative terminal end first into the aperture 43 the positive terminal end of a size C battery can be positioned above the open top 43 of the body 41 while the negative terminal end of the size C battery can be positioned against the conductor plate 45 in the bottom end 44 of the body 41 of the third piece 40. This will allow the positive terminal end to extend above the open end 43 of the body 41 and the entire third piece 40 and size C battery to be inserted in an electronic device designed to accept a size D battery. The positive terminal end of the size C battery will contact a positive terminal in the electronic device and the bottom end 44 and the conductor plate 45 on the bottom end 44 of the third piece 40 will contact the negative contact terminal (typically a coil spring) in the electronic device thereby allowing the size C battery to supply power to the electronic device designed for a size D battery.

In one aspect, the height of the third piece 40 could be approximately 55 mm with the height of conductor plate 45 being approximately 10 mm making the depth of the inner aperture 42 approximately 45 mm.

To use a size AA battery in place of a size D battery, the size AA battery can be inserted into the inner aperture 32 of the second piece 30 and the second piece 30 inserted into the inner aperture 42 of the body 41 of the third piece 40. The negative end of the size AA battery will be in contact with the conductor plate 35 of the second piece 30 and when the second piece 30 is inserted in the inner aperture 42 of the third piece 40, the conductor plate 35 of the second piece 30 will be placed in contact with the conductor plate 45 of the third piece 40, placing the negative terminal end of the size AA battery in electrical communication with the conductor plate 45 on the bottom end 44 of the third piece 40 through the conductor plate 35 of the second piece 30. In this manner, the size AA battery, second piece 30 and third piece 40 can together be used in a device that is meant to take a size D battery.

To use a size AAA battery in place of a size D battery, the size AAA battery can be inserted into the inner aperture 22 of the first piece 20 and the first piece 20 inserted into the inner aperture 32 of the body 31 of the second piece 30. The conductor plate 25 on the bottom of the first piece 20 will be in contact with the negative terminal end of the size AAA battery and therefore in electrical communication with the negative terminal end of the size AAA battery. This conductor plate 25 will also be placed in contact with the conductor plate 35 on the bottom end 34 of the second piece 30. The size AAA battery, first piece 20 and second piece 30 can then all be inserted into the inner aperture 42 of the third piece 40. The conductor plate 45 in the bottom end 44 of the third piece 40 can be placed in contact with the conductor plate 35 on the bottom end 34 of the second piece 30 so that they are in electrical communication with one another. In this manner, the negative terminal end of the size AAA battery will be placed in electrical communication with the conductor plate 45 on the bottom end 44 of the third piece 40 through the conductor plates 25, 35. In this manner, a size AAA battery can be used in a device that is meant to take a size D battery using the first piece 20, second piece 30 and third piece 40 altogether.

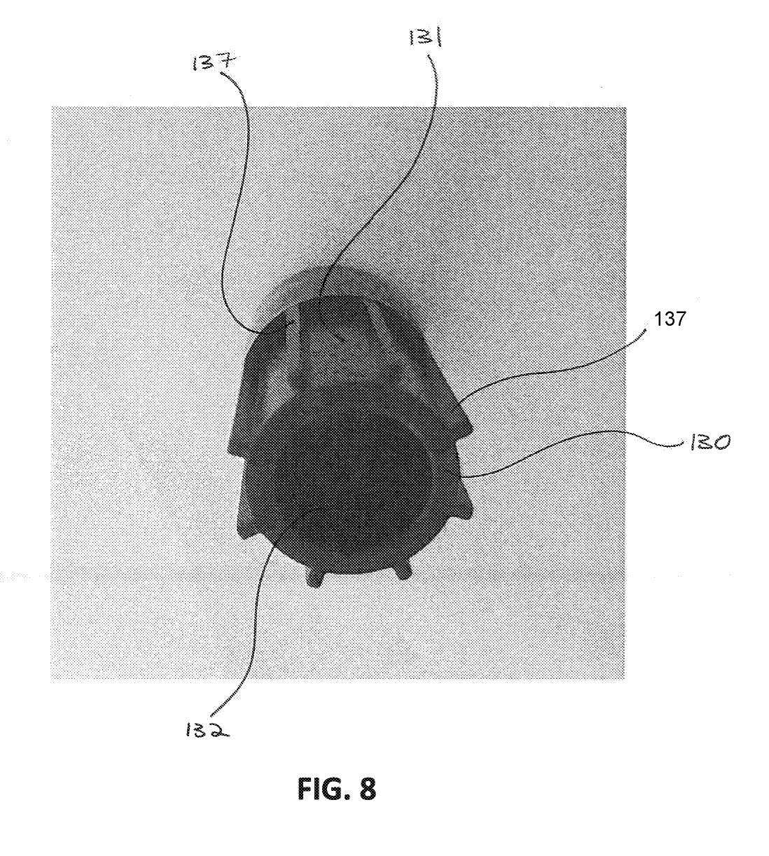

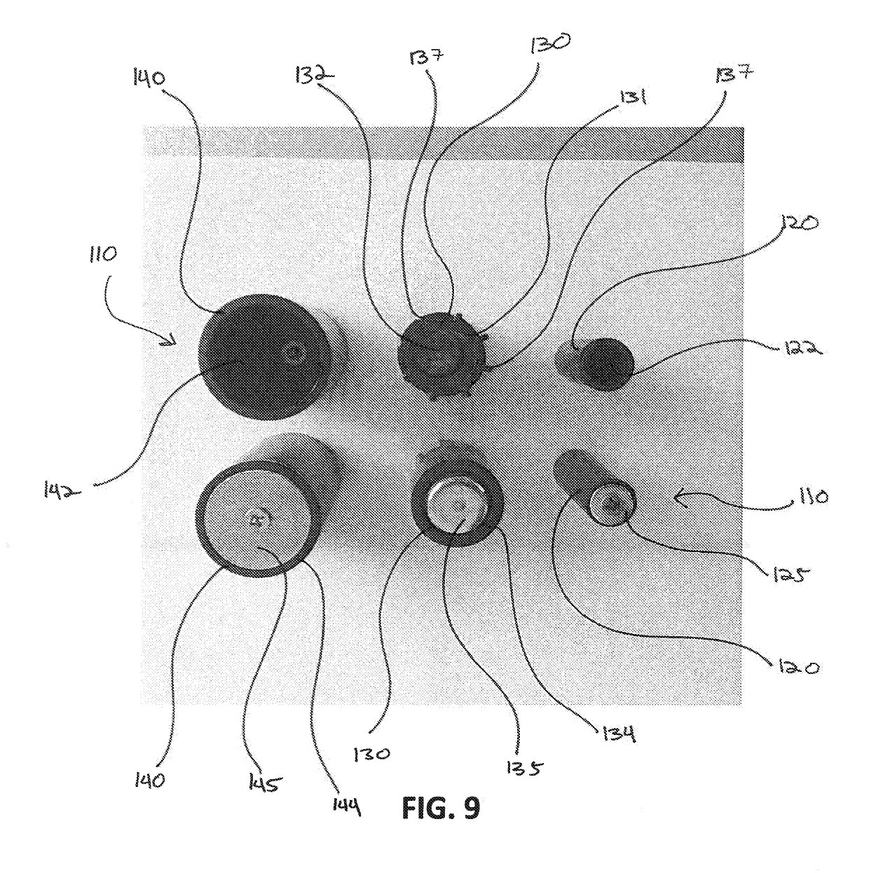

In the aspect shown in FIGS. 8 and 9, a second piece 130 of a battery conversion system 110 has a generally cylinder shaped body 131 with an inner aperture 132 sized to receive a size AA battery. In one aspect, the diameter of the inner aperture 132 could be approximately 14 mm to receive a size AA battery and allow a first piece 120 to be inserted in the inner aperture 132 of the second piece 130. The outer diameter of the generally cylindrical shaped body 131 could be sized to conform generally with the outer diameter of size C battery, but this is not strictly necessary. In one aspect, the outer diameter of the generally cylinder shaped body 131 could be approximately 25 mm.

The body 131 can comprise a plurality of radially extending ribs 137. In some aspects, the radially extending ribs can extend the full height of the second piece, from the open top end to the conductor plate on the bottom end. In some aspects, such as the aspect shown in FIGS. 8 and 9, the radially extending ribs 137 extend only partially along the height of the second piece 130. While in some aspects the radially extending ribs could extend along the inner aperture of the second piece so that a distal end of the radially extending ribs extend inwardly of the second piece toward the first piece 120, in the aspect shown in FIGS. 8 and 9, the radially extending ribs 135 extend outwardly of the second piece 130.

The conductor plate 135 of the second piece 130 can have a diameter that is greater than the inner diameter of the inner aperture 132 provided in the body 131 of the second piece 130. In this manner, the edges of the conductor plate 135 will extend out beyond the edges of a typical negative terminal of a size AA battery. In one aspect, the conductor plate 135 can have a diameter of approximately 17 mm causing the edges of the conductor plate 135 to extend out 3 mm more than the inner diameter of the inner aperture 132.

All of the pieces 120, 130, and 140 of FIG. 9 can be used together, while in some aspects only the first and second pieces 120, 130 can be used together, while in yet other aspects, only the first piece can be used 120. In use altogether, a size AAA battery can be inserted into the inner aperture 122 of the first piece 120 and the first piece 120 inserted into the inner aperture 132 of the body 131 of the second piece 130. The conductor plate 125 on the bottom of the first piece 120 will be in contact with the negative terminal end of the size AAA battery and therefore in electrical communication with the negative terminal end of the size AAA battery. This conductor plate 125 will also be placed in contact with the conductor plate 135 on the bottom end 134 of the second piece 130. The size AAA battery, first piece 120 and second piece 130 can then all be inserted into the inner aperture 142 of the third piece 140. The conductor plate 145 in the bottom end 144 of the third piece 140 can be placed in contact with the conductor plate 135 on the bottom end 134 of the second piece 130 so that they are in electrical communication with one another. In this manner, the negative terminal end of the size AAA battery will be placed in electrical communication with the conductor plate 145 on the bottom end 144 of the third piece 140 through the conductor plates 125, 135.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A battery conversion device comprising:
a generally cylindrical body comprising:
an open top end;
a bottom end; and
an inner aperture sized to be larger than an outer diameter of a size AA battery; and
a conductor plate having a diameter greater than the diameter of the size AA battery and provided on the bottom end of the body.

2. The battery conversion device of claim 1 wherein the diameter of the inner aperture is approximately 14 mm.

3. The battery conversion device of claim 1 wherein the outer diameter of the generally cylindrical body is sized to conform generally with the outer diameter of a size C battery.

4. The battery conversion device of claim 1 wherein the generally cylindrical body comprises a plurality of radially extending ribs.

5. The battery conversion device of claim 1 wherein the diameter of the conductor plate is approximately 17 mm.

6. A battery conversion system comprising:
a first piece having a generally cylindrical body with an open top end, a bottom end, an inner aperture sized to be larger than an outer diameter of a size AAA battery and a conductor plate provided on the bottom end; and
a second piece having a generally cylindrical body with an open top end, a bottom end, an inner aperture sized to be larger than an outer diameter of the first piece and a conductor plate having a diameter greater than the diameter of the inner aperture of the first piece and provided on the bottom end of the second piece.

7. The battery conversion system of claim 6 further comprising a third piece having a generally cylindrical body with an open top end, a bottom end, an inner aperture sized to be larger than an outer diameter of the second piece and a conductor plate provided on the bottom end of the third piece.

8. The battery conversion device of claim 6 wherein the diameter of the conductor plate of the second piece is approximately 17 mm.

9. The battery conversion system of claim 6 wherein the diameter of the inner aperture of the second piece is sized to receive at least one of a size AA battery and the first piece.

10. The battery conversion system of claim 9 wherein the diameter of the inner aperture of the second piece is approximately 14 mm.

11. The battery conversion system of claim 6 wherein the outer diameter of the generally cylindrical body of the second piece is sized to conform generally with the outer diameter of a size C battery.

12. The battery conversion system of claim 6 wherein the inner diameter of the first piece is sized to receive a size AAA battery.

13. The battery conversion system of claim 6 wherein the outer diameter of the first piece is sized to conform generally with the outer diameter of a size AA battery.

14. The battery conversion system of claim 7 wherein the inner diameter of the third piece is sized to receive at least one of a size C battery and the second piece.

15. The battery conversion system of claim 7 wherein the outer diameter of the third piece is sized to conform generally with the outer diameter of a size D battery.

16. The battery conversion system of claim 6 wherein the generally cylindrical body of the second piece comprises a plurality of radially extending ribs.

17. A method of substituting a smaller battery for a larger battery comprising the steps of:
providing a battery conversion device comprising:
a generally cylindrical body having an open top end, a bottom end, and an inner aperture sized to be larger than an outer diameter of a size AA battery; and
a conductor plate having a diameter greater than the diameter of the size AA battery and provided on the bottom end of the body; and
inserting a negative end of a size AA battery in the inner aperture whereby the negative end of the size AA battery contacts the conductor plate in the bottom end of the body.

18. A method of substituting a smaller battery for a larger battery comprising the steps of:
providing a first piece having a generally cylindrical body with an open top end, a bottom end, an inner aperture sized to be larger than an outer diameter of a size AAA battery and a conductor plate provided on the bottom end;
providing a second piece having a generally cylindrical body with an open top end, a bottom end, an inner aperture sized to be larger than an outer diameter of the first piece and a conductor plate having a diameter greater than the diameter of the inner aperture of the first piece and provided on the bottom end of the second piece; and
inserting one of a negative end of a size AA battery and the bottom end of the first piece in the inner aperture of the second piece whereby one of the negative end of the size AA battery and the conductor plate of the first piece contacts the conductor plate in the bottom end of the body of the second piece.

19. The method of claim 18 further comprising the steps of:
providing a third piece having a generally cylindrical body with an open top end, a bottom end, an inner aperture sized to be larger than an outer diameter of the second piece and a conductor plate provided on the bottom end of the third piece; and
inserting one of a negative end of a size C battery and the bottom end of the second piece in the inner aperture of the third piece whereby one of the negative end of the size C battery and the conductor plate of the second piece contacts the conductor plate in the bottom end of the body of the third piece.
